(19) United States
(12) Patent Application Publication
(10) Pub. No.: US 2002/0168531 A1
(43) Pub. Date: Nov. 14, 2002

(54) Two-ply polyurethane/geotextile composite and process for preparing the same

(76) Inventors: Peter H. Markusch, Pittsburgh, PA (US); Ralf Guether, Pittsburgh, PA (US)

Correspondence Address: BAYER CORPORATION, PATENT DEPARTMENT, 100 BAYER ROAD, PITTSBURGH, PA, 15205, US

(21) Appl. No.: 09/808,812

(22) Filed: Mar. 15, 2001

(51) Int. Cl. B32B 27/00

(52) U.S. Cl. 428/423.1

(57) ABSTRACT

Two-ply polyurethane geotextile composites suitable for lining ditches and canals in which a rigid, dimensionally stable geotextile is bonded to a soft, pliable geotextile with a solidifiable, liquid polyurethane composition which is a reaction product of a mixture of a liquid polyisocyanate having an NCO content of at least 10% by weight, an isocyanate-reactive component which includes at least one high molecular weight polyether polyol and a urethane catalyst are made, preferably at the site where the composite will be used.

### TECHNICAL FIELD OF THE INVENTION

The present invention relates to a two-ply polyurethane geotextile composite and to a process for preparing the same. Specifically, the invention relates to a two-ply polyurethane geotextile composite comprising at least one rigid, dimensionally stable geotextile, at least one non-rigid, soft, pliable geotextile, and a polyurethane composition which bonds the rigid geotextile and the non-rigid geotextile. The invention also relates to a process for preparing a two-ply polyurethane geotextile composite in which a solidifiable liquid polyurethane composition is brought into contact with a rigid, dimensionally stable geotextile and a non-rigid, soft, pliable geotextile in a manner such that these geotextiles are bonded together to form a polyurethane geotextile composite. The present invention also relates to a canal or ditch lined with such a two-ply polyurethane geotextile composite.

### BACKGROUND OF THE INVENTION

In recent years, the management of natural resources has become important in many countries throughout the world. Efforts have been directed both toward the conservation of our resources and toward the elimination of pollution from our environment. Particular emphasis has been placed on waste leakage and water loss.

Losses in the distribution of water using unlined irrigation ditches are estimated at a minimum to be 25% and in some situations to be more than 50% depending upon the porosity of the ditch surface and the distance the water is being moved. In most rural areas, ditches are formed by excavating the soil to the desired depth and width. The water moves through the ditch in contact with the exposed natural surface. This can be sand, clay, rocks, etc. and, more commonly, mixtures thereof. The porosity will depend upon the proportions of the different components in the soil.

The loss of water in unlined irrigation ditches at one time was considered acceptable only because the supply of water exceeded demand. However, as civilization develops and world population increases, more water is required for both greater food production and for the markedly increasing non-agriculture uses of water. In addition to greater domestic uses of water in sanitation, industry now employs large quantities of water in manufacturing and processing procedures.

This high level of consumption plus the very high cost of developing new water supplies has shifted attention to water conservation. Domestic appliances that use less water have been developed. Also, industry has installed recycling purification systems to reduce water consumption.

Although conservation efforts have reduced water consumption to a degree, water is still in relatively short supply, particularly in recent years with the severe droughts in the United States and other countries. Since the most cost effective conservation opportunities and readily accessible water supplies already have been developed, greater attention must be directed to improving the efficiency of water distribution systems.

Improvements in water distribution have been made. A limited number of ditches and canals have been lined with placed concrete and/or preformed concrete pipes. Concrete is durable and has a long life when properly used. However, concrete is expensive to place and finish and is damaged by unfavorable temperatures during curing. Also, concrete is subject to frost damage, cracking and heaving which results in leaks.

Polyvinylchloride (PVC) pipes and PVC-lined ditches have also been used to some extent in water distribution systems. PVC is less costly than concrete. The limited durability of PVC liners can be improved to a degree by burying the liner under several feet of soil. The soil holds the liner in place and cushions it against damage. However, both with concrete and PVC, considerable site preparation is required and after placement, extra grading and filling are frequently needed to finish the job.

There exists a need for a low cost, easy to install liner composite which is both flexible and durable.

Ditch liners are known. U.S. Pat. No. 4,872,784, for example, discloses a ditch liner composed of a solidifiable liquid mixture and a porous blanket. Suitable porous blankets include woven, knit, and non-woven structures.

Processes for forming polyurethane composite liners for canals and ditches and apparatus to perform such a processes are disclosed, for example, in U.S. Pat. Nos. 4,872,784; 4,955,759; 4,955,760; 5,049,006; 5,062,740; 5,421,677; 5,607,998; and 5,654,064.

U.S. Pat. No. 5,654,064 discloses a liner for use in containing liquid. The liner is made with two non-biodegradable geotextiles, a layer of water-swellable clay between the two geotextiles, and stitching means, for connecting the two geotextiles. The stitching extends through the clay layer and connects the geotextiles. The layer of water-swellable clay is bonded to at least one of the geotextiles.

U.S. Pat. No. 5,421,677 (“the '677 patent”) is directed to an improved process for forming a ditch liner. The '677 patent discloses the use of a mixture of one or more polyisocyanates, a polyol mixture, one or more fillers, and a catalyst. The mixture of the '677 patent is dispensed on a geotextile, thereby forming a liquid polyurethane soaked geotextile composite. The liquid polyurethane soaked geotextile composite is then placed over the surface of an area to be lined and allowed to cure, to form a polyurethane/geotextile composite.

The liquid polyurethane soaked geotextile composite of the '677 patent is preferably produced using a machine as described in U.S. Pat. No. 4,872,784 (“the '784 patent”).

The geotextile used in the '784 patent is preferably a geotextile that is rigid and dimensionally stable in order to avoid deformation and the potential for tearing when the liquid polyurethane soaked geotextile is pulled from the apparatus. One or more of these rigid geotextiles can be used in the preparation of a composite liner. However, due to the rigidity of the geotextile, wrinkles and openings are often formed in the overlapping areas (seams), resulting in potential leakage of water. Seepage occurs behind the liner through the openings and may result in delamination of the liner from the surface. Cutting out the wrinkles in the liner and patching them is possible. However, cutting and patching the composite liner not only weakens the liner, but also requires manual labor, which then increases the cost of installing and/or maintaining the liner. One disadvantage of using a rigid, dimensionally stable composite alone is the limitation in thickness necessary to ensure that the geotextile is permeable enough to allow the liquid polyurethane to penetrate through the geotextile and adhere to the surface of a ditch and/or canal.

In earthen ditches (which usually have a much more irregular surface compared with concrete ditches), the wrinkling problem is even greater. Earthen ditches also require a liner having greater thickness and mechanical stability. The wrinkling thickness and mechanical stability concerns cannot be addressed by rigid, dimensionally stable geotextiles.

For the foregoing reasons, it would be desirable to develop a two-ply polyurethane geotextile composite that does not have the above-mentioned shortcomings. Specifically, it would be desirable to develop a two-ply polyurethane geotextile composite that can be applied over uneven surfaces but which avoids wrinkling, and which can provide the thickness and mechanical stability needed in earthen canals.

### SUMMARY OF THE INVENTION

The invention is directed toward a two-ply polyurethane geotextile composite in which a solidifiable liquid polyurethane composition bonds at least one rigid, dimensionally stable geotextile and at least one soft, pliable geotextile.

The present invention is also directed to a process for producing such a composite, a process for lining a ditch or a canal with such composite and to ditches and canals lined with such a composite. The polyurethane composition which bonds the two different types of geotextiles is a reaction product of a mixture which includes:

a) a liquid polyisocyanate having an isocyanate content of at least 10% by weight,

b) an isocyanate reactive component which includes one or more polyether polyols having from 2 to 6 hydroxyl groups and a number average molecular weight of from at least 250 to 8,000 and 0 to 10% by weight based on total weight of b) of a low molecular weight diol or triol having an equivalent weight of from 31 to 99,

c) an organo-metallic catalyst; and optionally,

d) a filler.

Such a two-ply polyurethane geotextile composite may be made by applying a solidifiable liquid polyurethane composition to a rigid, dimensionally stable geotextile and/or a soft, pliable geotextile and bringing these two different types of geotextiles into contact, or by impregnating one or both of the geotextiles with the polyurethane and contacting the impregnated geotextiles with the other geotextile and then allowing the polyurethane to cure.

The flexibility of the two-ply polyurethane geotextile composite allows for more efficient installation of the composite on a surface, for example, as a liner for a ditch and/or canal, where the surface may at times be uneven. Additionally, the use of two different types of geotextiles results in a strong and durable composite. These and other advantages of the present invention will become better understood by the following description of the invention and the appended claims.

### DETAILED DESCRIPTION OF THE INVENTION

The present invention is directed toward a two-ply polyurethane geotextile composite in which a solidifiable liquid polyurethane composition bonds at least one rigid, dimensionally stable geotextile and at least one soft, pliable geotextile. The solidifiable liquid polyurethane composition which bonds the two different types of geotextiles is a reaction product of a mixture which includes:

a) a liquid polyisocyanate having an isocyanate content of at least 10% by weight,

b) an isocyanate reactive component which includes one or more polyether polyols having from 2 to 6 hydroxyl groups and a number average molecular weight of from at least 250 to 8,000 (also referred to herein as “high molecular weight polyether polyols”) and from 0 to 10% by weight, based on total weight of b), of a low molecular weight (i.e., number average molecular weight less than 250) diol or triol having an equivalent weight of from 31 to 99,

c) an organometallic catalyst, preferably in an amount of up to 0.5 parts by weight per hundred parts by weight of polyol b) and optionally,

d) filler.

The invention is also directed toward a process for making such a two-ply polyurethane geotextile composite comprising applying the solidifiable liquid polyurethane composition to a rigid, dimensionally stable geotextile and/or a soft, pliable geotextile and bringing these two different types of geotextile into contact with each other or by impregnating one or both of the geotextiles with the solidifiable liquid polyurethane composition and contacting the impregnated geotextile with the other geotextile and then allowing the polyurethane to cure.

The invention is also directed toward a canal or ditch lined with such a two-ply polyurethane geotextile composite.

As used herein, the term “geotextile” refers to any woven or non-woven porous blanket or mat which is produced from natural or synthetic fibers. Also, as used herein, the terms “ditch” and “canal” are used interchangeably and can refer to any liquid-carrying surface having a sloped side or depression therein. Geotextiles are used primarily to line earthen surfaces. Such liners may, however, also be used in lining roofs, ponds, reservoirs, landfills, and underground storage tanks, canals and ditches. Examples of geotextiles include woven or non-woven polypropylene, polyester, jute, cotton and fiberglass fabrics.

The substantially rigid, dimensionally stable geotextile used in the present invention may be any of the known rigid, porous geotextiles. Examples of suitable rigid dimensionally stable geotextiles are woven or non-woven fabrics prepared from polypropylene, polyester, cotton, jute or glass fiber. A preferred substantially rigid geotextile is a non-woven polypropylene with excellent dimensional stability that can be easily penetrated by the solidifiable liquid polyurethane composition. A more preferred substantially rigid geotextile is a non-woven polypropylene with excellent dimensional stability having a thickness of less than 1 mm that can be easily penetrated by the solidifiable liquid mixture.

The non-rigid geotextiles useful in the present invention include any of the known substantially soft, pliable geotextiles, particularly any of the known porous fabrics that can be easily soaked or impregnated with the solidifiable liquid polyurethane composition. Preferred soft, pliable geotextiles are polyester and polypropylene fabrics having a minimum thickness of 1 mm. A more preferred non-rigid geotextile is a polyester or polypropylene fabric having a minimum thickness of 1 mm and one side burnished.

Any of the known liquid isocyanates having an isocyanate content of at least 10% by weight, preferably at least 20% by weight, most preferably at least 30% by weight, are useful in the practice of the present invention. Suitable liquid organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Such isocyanates include those represented by the formula Q(NCO)ₙ in which n represents a number from 2 to about 5, preferably 2 to 3, and Q represents an aliphatic hydrocarbon group containing from 2 to about 18, preferably from 6 to 10, carbon atoms, a cycloaliphatic hydrocarbon group containing from 4 to about 15, preferably from 5 to 10, carbon atoms, an araliphatic hydrocarbon group containing from 8 to 15, preferably from 8 to 13, carbon atoms, or an aromatic hydrocarbon group containing from 6 to about 15, preferably from 6 to 13, carbon atoms. Examples of suitable isocyanates include: ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and 1,4-diisocyanate, and mixtures of these isomers; 1-isocyanato-3,3,5-trimethyl-isocyanatomethylcyclohexane (“isophorone diisocyanate” (see, e.g. German Offenlegungsschrift 1,202,785 and U.S. Pat. No. 3,401,190)); 2,4- and 2,6-hexahydrotoluene diisocyanate and mixtures of these isomers; dicyclohexylmethane-4,4′-diisocyanate (“hydrogenated MDI”, or “HMDI”); 2,4- and 2,6-toluene diisocyanate and mixtures of these isomers (“TDI”); diphenylmethane-2,4′- and/or -4,4′-diisocyanate (“MDI”); polymethylene poly(phenylisocyanates) of the kind which may be obtained by condensing aniline with formaldehyde, followed by phosgenation (“crude MDI”) (which are described, for example, in British Patents 878,430 and 848,671); norbornane diisocyanates (such as described in U.S. Pat. No. 3,492,330); m- and p-isocyanatophenyl sulfonylisocyanates (of the type described in U.S. Pat. No. 3,454,606); perchlorinated aryl polyisocyanates (of the type described, for example, in U.S. Pat. No. 3,227,138); modified polyisocyanates containing carbodiimide groups (of the type described in U.S. Pat. No. 3,152,162); modified polyisocyanates containing urethane groups (of the type described, for example, in U.S. Pat. Nos. 3,394,164 and 3,644,457); modified polyisocyanates containing allophanate groups (of the type described, for example, in British Patent 994,890, Belgian Patent 761,616, and published Dutch Patent Application 7,102,524); modified polyisocyanates containing isocyanurate groups (of the type described, for example, in U.S. Pat. No. 3,002,973, German Patentschriften 1,022,789, 1,222,067 and 1,027,394, and German Offenlegungsschriften 1,919,034 and 2,004,048); modified polyisocyanates containing urea groups (of the. type described in German Patentschrift 1,230,778); polyisocyanates containing biuret groups (of the type described, for example, in German Patentschrift 1,101,394, U.S. Pat. Nos. 3,124,605 and 3,201,372, and in British Patent 889,050); polyisocyanates obtained by telomerization reactions (of the type described, for example, in U.S. Pat. No. 3,654,106); polyisocyanates containing ester groups (of the type described, for example, in British Patents 965,474 and 1,072,956, in U.S. Pat. No. 3,567,763, and in German Patentschrift 1,231,688); reaction products of the above-mentioned isocyanates with acetals (as described in German Patentschrift 1,072,385); and polyisocyanates containing polymeric fatty acid groups (of the type described in U.S. Pat. No. 3,455,883). It is also possible to use the isocyanate-containing distillation residues accumulating in the production of isocyanates on a commercial scale, optionally in solution in one or more of the polyisocyanates mentioned above. It is also possible to use mixtures of the polyisocyanates described above.

In general, it is preferred to use readily available polyisocyanates, such as 2,4- and 2,6-toluene diisocyanates and their isomer mixtures (“TDI”); diphenyl methane diisocyanate (“MDI”); polymethylene poly(phenylisocyanates) of the type obtained by condensing aniline with formaldehyde, followed by phosgenation (“crude MDI”); and polyisocyanates containing carbodiimide groups, urethane groups, allophanate groups, isocyanurate groups, urea groups, or biuret groups (“modified polyisocyanates”). Aromatic polyisocyanates, particularly the commercially available phosgenation products of aniline/formaldehyde condensates are particularly preferred isocyanates. Polymethylene poly(phenylisocyanates) having NCO contents of from about 30 to 33% and a viscosity of from about 20 to 2,000 mPa·s at 25° C. are among the most preferred polyisocyanates.

Suitable high molecular weight isocyanate reactive compounds useful as component b) include any of the known polyether polyols, particularly any polyether polyol having from 2 to 6, preferably from 2 to 4, most preferably 2 or 3 hydroxyl groups and a number average molecular weight of from at least 250 to about 8,000, preferably from about 400 to about 4,000, most preferably from about 400 to about 2,000.

Such polyether polyols may be prepared, for example, by the polymerization of epoxides such as ethylene oxide, propylene oxide, butylene oxide, tetrahydrofuran, styrene oxide, or epichlorohydrin, optionally in the presence of Lewis acids such as BF₃, or prepared by chemical addition of such epoxides, optionally added as mixtures or in sequence, to starting components containing reactive hydrogen atoms, such as water, alcohols, or amines. Examples of suitable starting components include ethylene glycol, 1,3- or 1,2-propanediol, 1,2-, 1,3-, or 1,4-butanediol, trimethylolpropane, 4,4′-dihydroxydiphenylpropane, aniline, ammonia, ethanolamine, and ethylene diamine. Sucrose polyethers of the type described, for example, in German Offenlegungsschriften 1,176,358 and 1,064,938 may also be used in the present invention. Polyethers which contain predominantly primary hydroxyl groups (up to about 90% by weight, based on all of the hydroxyl groups in the polyether) are also suitable. Polyethers modified by vinyl polymers of the kind obtained, for example, by the polymerization of styrene and acrylonitrile in the presence of polyethers (e.g., U.S. Pat. Nos. 3,383,351, 3,304,273, 3,523,093, and 3,110,695 and German Patent 1,152,536) are also suitable, as are polybutadienes containing hydroxyl groups. Particularly preferred polyether polyols include polyoxyalkylene polyether polyols, such as polyoxyethylene diols, polyoxypropylene diols, polyoxybutylene diols, and polytetramethylene diols, as well as polyoxypropylene polyoxyethylene triols.

Other polyether polyols useful in component b) include the so-called “PHD polyols”, which are prepared by reaction of an organic polyisocyanate, hydrazine, and polyether polyol. U.S. Pat. No. 3,325,421 discloses a method for producing suitable PHD polyols by reacting a stoichiometric or substoichiometric quantity (relative to diamine) of polyisocyanate dissolved in a polyol having a molecular weight of at least 500 and a hydroxyl number of no more than 225. See also U.S. Pat. Nos. 4,042,537 and 4,089,835.

Polymer polyols are also useful as component b). Polymer polyols, may be prepared by polymerizing styrene and acrylonitrile in the presence of a polyether. See, for example, U.S. Pat. Nos. 3,383,351, 3,304,273, 3,523,093, 3,652,639, 3,823,201 and 4,390,645.

Particularly preferred polyethers include polyoxypropylene polyethers that do not contain ethylene oxide units.

Mixtures of polyether polyols are also particularly advantageous in the practice of the present invention. Particularly preferred polyether polyol mixtures include: (i) from about 5 to about 15 parts by weight (based on total weight of polyol) of a propylene oxide adduct of an alkanolamine which has a number average molecular weight of from about 250 to about 1,000; (ii) a propylene oxide adduct of a low molecular weight organic compound having from about 3 to 6 OH groups and a number average molecular weight of from about 250 to 1,000; and (iii) a propylene oxide adduct of a low molecular weight diol having a number average molecular weight of from about 250 to 3,000.

Any of the known organic diols or triols may optionally be included in the isocyanate reactive component b) of the present invention in an amount of up to 10% by weight. Suitable organic diols and triols have equivalent weights of from about 31 to 99. Examples of such diols and triols include: 2-methyl-1,3-propanediol; ethylene glycol; 1,2- and 1,3-propanediol; 1,3-, 1,4- and 2,3-butanediol; 1,6-hexanediol; 1,10-decanediol; diethylene glycol; triethylene glycol; tetraethylene glycol; dipropylene glycol; tripropylene glycol; glycerol; trimethylolpropane; neopentyl glycol; cyclohexanedimethanol; and 2,2,4-trimethylpentane-1,3-diol. Preferred diols and triols include dipropylene glycol and tripropylene glycol.

The polyurethane-forming reaction mixture also includes a catalyst c) for catalyzing the reaction between isocyanate groups and hydroxyl groups (i.e., a urethane catalyst). Such catalysts are well known in the art. Suitable catalysts include organometallic compounds. Preferred catalysts c) are organic tin compounds. The organic tin compounds preferably used are tin(II) salts of carboxylic acids such as tin(II) acetate, tin(II) octoate, tin (II) ethyl hexoate and tin (II) laurate and tin (IV) compounds such as dibutyl tin oxide, dibutyl tin dichloride, dibutyl tin diacetate, dibutyl tin dilaurate, dibutyl tin maleate, dioctyl tin diacetate and the like. Of course, it is also possible to use any of the other urethane catalysts which are well known to those skilled in the art of polyurethane chemistry.

The catalyst can be added separately to the polyurethane-forming reaction mixture or combined with the isocyanate-reactive component b) prior to combining the isocyanate reactive component with the polyisocyanate.

Catalysts which would catalyze the reaction between an isocyanate group and water (i.e., tertiary amine catalysts) should not, however, be used in the polyurethane-forming reaction mixture.

The urethane catalyst is generally used in an amount of from 0.0001 to 5 parts by weight per 100 parts by weight of component b), preferably from about 0.001 to 0.1 parts by weight.

Optionally, any of the known fillers may be included in the polyurethane-forming reaction mixture of the present invention. Useful fillers include calcium carbonate, barium sulfate, kieselguhr, whiting, mica, glass fibers, liquid crystal fibers, glass flakes, glass balls, aramide fibers, and carbon fibers. In addition, ground solid plastics (such as polyurethane scrap), rubber wastes (such as from tires), or any kind of ground rubber may be used.

If a filler is used, it may be added to either polyisocyanate component a) or isocyanate-reactive component b) prior to forming the liquid polyurethane-forming reaction mixture or it may be separately metered into the polyurethane-forming reaction mixture.

In the practice of the invention, the liquid polyisocyanate component a) is mixed with the isocyanate reactive component b) in the presence of a urethane catalyst c) and optionally, filler d) at an NCO:OH equivalent ratio from 1.4:1 to 0.9:1, preferably from 1.1:1.0 to 1.0:1.0.

In one embodiment of the present invention, a ditch or canal is lined with a composite of the present invention using a machine such as that described in U.S. Pat. No. 5,639,331 (“the '331 patent”).

The '331 patent teaches a mobile ditch lining apparatus comprising reservoirs for supplying raw materials such as resin, catalysts, fillers, colors or other additives. The reservoirs are connected to a mixing chamber through flexible conduit means. The delivery rate of the raw materials to the mixing chamber will vary depending upon the particular formulation and quantity thereof required for the specific area of the liner being formed. In the process of the present invention, the polyisocyanate, isocyanate-reactive component, catalyst and optional filler are mixed in the mixing chamber.

From the mixing chamber, the polyurethane composition is applied between a rigid, dimensionally stable geotextile and a soft, pliable geotextile. The geotextiles are pulled from a vat containing the polyurethane composition through an adjustable die. The opening of the die provides even distribution of the polyurethane reaction mixture on the geotextiles, determines how much polyurethane is dispensed on the geotextiles, and also controls the thickness of the polyurethane-impregnated geotextile composite. The two-ply polyurethane-impregnated geotextile is then cut to the desired length and placed in the canal or ditch where it conforms to the surface and cures to form a two-ply polyurethane geotextile composite liner. Installing the polyurethane-impregnated geotextile liners in such a way that they overlap to a certain extent assures that after curing a seamless permanent flexible two-ply polyurethane composite liner is obtained.

In another embodiment of the present invention, the polyurethane composition is applied to a rigid, dimensionally stable geotextile by spraying using commercially available two-component polyurethane spray equipment. The polyurethane-impregnated rigid, dimensionally stable geotextile is then placed in the ditch or canal. Subsequently the soft, pliable geotextile is placed on top of the polyurethane-impregnated rigid dimensionally stable geotextile and the liquid polyurethane composition is absorbed by the soft, pliable geotextile. The layered geotextiles conform to the surface and the polyurethane cures to form a two-ply polyurethane geotextile composite. The rigid, dimensionally stable geotextile can also be cut to size, placed in the canal or ditch and subsequently impregnated with the polyurethane composition by spraying the polyurethane onto that rigid geotextile. A soft, pliable geotextile may then be placed on top of the polyurethane-impregnated rigid, dimensionally stable geotextile. In this embodiment, it is preferred that the geotextiles with the still liquid polyurethane on it be rolled (e.g., with a paint roller) to cause the polyurethane to penetrate through the geotextiles to the surface of the ditch or canal.

In another embodiment of the invention, the liquid polyurethane composition is applied (e.g., by spraying) to the surface to be lined (e.g., the concrete surface of a ditch or canal). A rigid, dimensionally stable geotextile is then brought into contact with the surface to which the polyurethane has been applied. A soft, pliable geotextile is then placed on top of the rigid geotextile. Contact of the uncured polyurethane composition with both the rigid geotextile and the soft, pliable geotextile is made to an extent such that the two different geotextiles will be bonded to each other when the polyurethane is cured. The necessary contact can be ensured, for example, by applying sufficient pressure to the soft, pliable geotextile after it has been placed on the rigid geotextile to cause some of the polyurethane to permeate at least the surface of the soft geotextile which is in direct contact with the rigid geotextile but preferably, to permeate the entire soft geotextile layer.

State of the art sprayable polyurethane formulations are not useful in the present invention because they exhibit gel times of only several seconds. In order to prepare ditch or canal liners with polyurethane geotextile composites, a gel time of at least five minutes, preferably more than 10 minutes is required.

If additional layers of polyurethane composite are desirable, any of the above-described processes can be repeated one or more times.

The thickness of the polyurethane geotextile composite of the present invention can be varied over a wide range but usually measures from about 50 microns to about 500 microns.

The amount of polyurethane applied to the geotextiles can be varied but usually the polyurethane applied per square meter ranges from 1 kg to 20 kg, preferably from 2 kg to 5 kg.

If desirable, several layers of the polyurethane-impregnated geotextiles may be applied over each other to obtain a composite of higher strength and dimensional stability. Such multi-layered composites are actually preferred for lining an earthen canal or ditch.

The following examples further illustrate details for the preparation and use of the composites of this invention.

### EXAMPLE

The following materials were used in the Examples given below.

| | |
|---|---|
| Isocyanate A: | polymethylene poly (phenylisocyanate) having an |
| | NCO content of about 31.5%, a functionality of 2.6 |
| | and a viscosity at 25° C. of 200 mPa · s. |
| Polyol 1: | a monoethanolamine-started propylene oxide |
| | polyether polyol, having an OH number of about 350, |
| | a functionality of about 3 and a number average |
| | molecular weight of about 480. |
| Polyol 2: | a glycerine-started propylene oxide polyether polyol, |
| | having an OH number of about 250, a functionality of |
| | about 3 and a number average molecular weight of |
| | about 670. |
| Polyol 3: | a propylene glycol-started propylene oxide polyether |
| | polyol, having an OH number of 56, a functionality of |
| | about 2 and a molecular weight of about 2000. |
| Amine 1: | bis(4-aminocyclohexyl)methane |
| Catalyst A: | dimethyltin dilaurate, commercially available as |
| | Fomrez UL-28 from Witco. |
| Geotextile A: | Typar-3301, spunbonded polypropylene, 3 oz/yd², 12 |
| | mils thickness (Reemay) |
| Geotextile B: | FX-40HS, polypropylene, nonwoven, heatbonded, |
| | 4 oz/yd² (Carthage Mills) |
| Geotextile C: | Trevira Spunbound Type 1620, polyester, nonwoven, |
| | heatbonded, 5.7 oz/yd², 37 mils thickness, (Fluid |
| | Systems) |

The following polyol blend was used in the Examples:

| | |
|---|---|
| Polyol Blend A | 10 pbw Polyol 1 |
| | 45 pbw Polyol 2 |
| | 44 pbw Polyol 3 |
| | 0.01 pbw Catalyst A |

### Examples 1-3

99 g of Polyol Blend A, 1 g of Amine A, and 43.9 g of Isocyanate A were mixed and then poured onto a 1 sq ft piece of Geotextile A. The reaction mixture was spread out over Geotextile A with a spatula and 1 sq ft piece of a second Geotextile (A, B or C) was placed on top of the liquid polyurethane and Geotextile A. A rubber roller was then used to evenly distribute the polyurethane mixture between the geotexiles and also to roll off any excess of polyurethane. The gel time of the polyurethane was between 15 and 20 minutes and the material cured to a solid geotextilelpolyurethane composite in about 1 hour. The composite thickness ranged from 80 to 100 mils. The properties of the composites thus-produced were determined and those properties are reported in Table 1.

TABLE 1

| | Example 1* | Example 2 | Example 3 |
|---|---|---|---|
| Polyol Blend A | 99 | 99 | 99 |
| (grams) | | | |
| Isocyanate A | 43.9 | 43.9 | 43.9 |
| (grams) | | | |
| Amine 1 (grams) | 1 | 1 | 1 |
| Isocyanate Index | 105 | 105 | 105 |
| Catalyst A Concentration | 0.01 | 0.01 | 0.01 |
| (%) | | | |
| Geotextile Combination | 2 Geotextile | 1 Geotextile A | 1 Geotextile A |
| | A | 1 Geotextile C | 1 Geotextile B |
| Tensile Strength (psi) | 757 | 1284 | 1465 |
| Elongation (%) | 50 | 64 | 39 |
| Split Tear (pli) | 126 | 105 | 109 |
| Die “C” Tear | 196 | 205 | 248 |
| Puncture Test | 70 | 113 | 114 |

*comparative

Two-ply polyurethane geotextile composites within the scope of the present invention were prepared comprising one rigid, dimensional stable geotextile (Geotextile A) in combination with one soft, pliable geotextile (Geotextile B or C) in Examples 2 and 3. The data in Table 1 demonstrate the performance benefits of a two-ply polyurethane geotextile composite made with two different types of geotextile (Examples 2 and 3), over a combination of two identical rigid, dimensional stable geotextiles, as described in comparative Example 1.

Although the invention has been described in detail in the foregoing for the purpose of illustration, it is to be understood that such detail is solely for that purpose and that variations can be made therein by those skilled in the art without departing from the spirit and scope of the invention.

What is claimed is:

1. A two-ply polyurethane geotextile composite in which a rigid, dimensionally stable geotextile is bonded to a soft, pliable geotextile with the solidifiable liquid polyurethane composition which is a reaction product of a mixture comprising:
a) a liquid polyisocyanate having an isocyanate content of at least 10% by weight,
b) an isocyanate reactive component comprising a polyether polyol having from 2 to 6 hydroxyl groups and a number average molecular weight of from 250 to 8,000 and 0 to 10% by weight, based on total weight of b), of a low molecular weight diol or triol having an equivalent weight of from 31 to 99,
c) a urethane catalyst, and optionally,
d) a filler.

2. The composite of claim 1, wherein the polyether polyol b) comprises a polyoxypropylene polyether having a number average molecular weight of from about 400 to about 4,000 and an average functionality of 2 to 3.

3. The composite of claim 1, wherein the polyether polyol b) comprises:
(i) from about 5 to about 15 parts by weight of a propylene oxide adduct of an alkanolamine which adduct has a number average molecular weight of from 250 to about 1000,
(ii) a propylene oxide adduct of a low molecular weight organic compound having from about 3 to about 6 OH groups which adduct has a number average molecular weight of from 250 to 1000, and
(iii) a propylene oxide adduct of a low molecular weight diol which adduct has a number average molecular weight of from 250 to about 3000.

4. The composite of claim 1, wherein the catalyst c) comprises an organic tin compound.

5. The composite of claim 1, wherein the liquid polyisocyanate a) is an aromatic polyisocyanate.

6. The composite of claim 1, wherein the liquid polyisocyanate a) is a polymethylene poly(phenylisocyanate) having an NCO-content of about 30 to 33% and a viscosity of about 20 mPa·s to 2,000 mPa·s at 25° C.

7. The composite of claim 1, wherein the rigid, dimensionally stable geotextile has a maximum thickness of 1 mm.

8. The composite of claim 1, wherein the soft, pliable geotextile has a minimum thickness of 1 mm.

9. The composite of claim 1, wherein the soft, pliable geotextile has at least one side burnished.

10. The composite of claim 1, wherein the solidifiable liquid polyurethane composition does not include a filler d).

11. The composite of claim 1, wherein the polyether polyol b) does not include a low molecular weight diol or triol.

12. A process for producing a two-ply polyurethane geotextile composite comprising
(1) applying a solidifiable liquid polyurethane composition to at least one of a rigid, dimensionally stable geotextile or a soft, pliable geotextile, the solidifiable liquid polyurethane composition being a reaction product of a mixture comprising:
a) a liquid polyisocyanate having an isocyanate content of at least 10% by weight,
b) an isocyanate reactive component comprising a polyether polyol having from 2 to 6 hydroxyl groups and a number average molecular weight of from 250 to 8,000 and 0 to 10% by weight, based on total weight of b), of a low molecular weight diol or triol having an equivalent weight of from 31 to 99,
c) a urethane catalyst and optionally,
d) a filler,
(2) contacting the rigid geotextile and the soft, pliable geotextile in a manner such that the polyurethane composition will be capable of bonding those geotextiles, and
(3) allowing the polyurethane composition to cure.

13. The process of claim 12, wherein the polyether polyol b) comprises a polyoxypropylene polyether having a number average molecular weight of from about 400 to about 4,000 and an average functionality of from 2 to 3.

14. The process of claim 12, wherein the polyether polyol b) comprises:
(i) from about 5 to about 15 parts by weight of a propylene oxide adduct of an alkanolamine which adduct has a number average molecular weight from 250 to about 1000,
(ii) a propylene oxide adduct of a low molecular weight organic compound having from about 3 to about 6 OH groups which adduct has a number average molecular weight of from 250 to 1000, and
(iii) a propylene oxide adduct of a low molecular weight diol, which adduct has a number average molecular weight of from 250 to about 3000.

15. The process of claim 12, wherein the catalyst c) is an organic tin compound.

16. The process of claim 12, wherein the liquid polyisocyanate a) is an aromatic polyisocyanate.

17. The process of claim 12, wherein the liquid polyisocyanate a) is a polymethylene poly (phenylisocyanate) having an NCO-content of from about 30 to 33% and a viscosity of from about 20 to 2,000 mPa·s at 25° C.

18. The process of claim 12, wherein the rigid, dimensionally stable geotextile has a maximum thickness of 1 mm.

19. The process of claim 12, wherein the soft, pliable geotextile has a minimum thickness of 1 mm.

20. The process of claim 12, wherein the soft, pliable geotextile has at least one side burnished.

21. The process of claim 12, wherein the solidifiable liquid polyurethane composition does not include a filler d).

22. The process of claim 12, wherein the component b) does not include a low molecular weight diol or triol.

23. The process of claim 12, wherein two or more polyurethane composite liners are placed over each other.

24. The process of claim 12, wherein the polyurethane composition is applied onto of the rigid geotextile in step a).

25. A process for forming a two-ply polyurethane geotextile composite comprising
(1) applying a polyurethane composition onto a concrete surface of a ditch or canal by spraying,
(2) bringing a rigid, dimensionally stable geotextile into contact with surface to which the polyurethane has been applied,
(3) placing a soft, pliable geotextile on top of the rigid geotextile,
(4) ensuring that the polyurethane will come into contact with the soft, pliable geotextile to an extent such that the polyurethane can bond the rigid and soft geotextiles, and
(5) allowing the polyurethane to cure to form a polyurethane geotextile composite, the polyurethane composition comprising a reaction product of a mixture comprising:
a) a liquid polyisocyanate having an isocyanate content of at least 10% by weight,
b) an isocyanate reactive component comprising a polyether polyol having from 2 to 6 hydroxyl groups and a number average molecular weight of from at least 250 to 8,000 and 0 to 10% by weight, based on total weight of b), of a low molecular weight diol or triol having an equivalent weight of from 31 to 99,
c) a urethane catalyst, and optionally,
d) a filler.

26. A canal or ditch lined with a two-ply polyurethane geotextile composite produced by
(1) dispensing a polyurethane composition between at least one rigid, dimensionally stable geotextile and at least one soft, pliable geotextile,
(2) laying the product of (1) onto a surface of a canal or ditch before the polyurethane composition has fully cured,
(3) conforming the polyurethane/geotextile product laid in (2) to the shape of the surface of the canal or ditch, and
(4) allowing the polyurethane between the geotextile layers to fully cure to form a polyurethane geotextile composite liner in which the polyurethane composition dispensed in (1) is a reaction product of a mixture comprising:
a) a liquid polyisocyanate having an isocyanate content of at least 10% by weight,
b) an isocyanate reactive component comprising a polyether polyol having from 2 to 6 hydroxyl groups and a number average molecular weight of from at least 250 to 8,000 and 0 to 10% by weight, based on total weight of b), of a low molecular weight diol or triol having an equivalent weight of 31 to 99,
c) a urethane catalyst, and optionally,
d) a filler.

27. The canal or ditch according to claim 26, wherein the two-ply polyurethane composite is layed on the surface of a canal or ditch in a manner such that the rigid, dimensionally stable geotextile is in direct contact with the surface of the canal or ditch before the polyurethane has completely cured.
